(19) United States
(12) Patent Application Publication
(10) Pub. No.: US 2005/0007964 A1
(43) Pub. Date: Jan. 13, 2005

(54) Peer-to-peer network heartbeat server and associated methods

(76) Inventors: Vincent Falco, Miami Beach, FL (US); Dave Nicponski, Miami Beach, FL (US); Sam Darwin, North Bay Village, FL (US)

Correspondence Address: LOTT & FRIEDLAND, P.A., P.O. BOX 141098, CORAL GABLES, FL, 33114-1098, US

(21) Appl. No.: 10/881,570

(22) Filed: Jun. 30, 2004

Related U.S. Application Data
(60) Provisional application No. 60/484,141, filed on Jul. 1, 2003.

(51) Int. Cl. H04J 3/16; H04L 12/28

(52) U.S. Cl. 370/256

(57) ABSTRACT

A self-defined, automatically-configured hierarchical peer-to-peer networking method is disclosed. Network hierarchy is determined by the proximity (quantified as lower latency) of nodes in the network to a predetermined heartbeat server node. Nodes in closer proximity to the server node are considered parent of nodes in farther proximity. Nodes in equal proximity to the server node are considered siblings to each other. The disclosed network has a loop-free connectivity topology where a parent node may have multiple child nodes but does not share any child nodes with other parents.

### CLAIM OF PRIORITY

This application is a non-provisional of U.S. patent application Ser. No. 60/484,141, filed on Jul. 1, 2003, the contents of which are incorporated herein by reference.

### TECHNICAL FIELD

This invention relates generally to computer networks, and specifically to structure, operation, configuration and use of a novel peer-to-peer network (hereinafter “P2P network” or “peer-to-peer network” interchangeably). A peer-to-peer network is defined generally as a type of decentralized multi-node digital computer network in which all of the nodes have substantially equivalent capabilities and responsibilities. peer-to-peer networks may be contrasted with client/server architectures, in which some nodes are dedicated to serving (i.e., the servers) the remaining nodes (i.e., the clients.)

### BACKGROUND OF THE INVENTION

This invention relates specifically to the implementation of a novel peer-to-peer network, and methods associated therewith, for use in file searching and downloading applications by means of a digital computer network such as the Internet. There are numerous examples of peer-to-peer network architectures in use today, including Gnutella, Fasttrack, JXTA, Overnet, among others. All of these peer-to-peer networks utilize a model where multiple distributed nodes on the Internet maintain connections among themselves and do not depend on a central server for such communication.

Existing peer-to-peer network architectures suffer from significant drawbacks which relate directly to their decentralized nature. One disadvantage of existing peer-to-peer network architectures is that there is no simple or efficient method to count and identify the number of nodes connected to the network at any one time. Known methods for counting nodes in a peer-to-peer network include the following:

(1) Implementation of a “crawler”, which is a program run from a node on the network that contacts other nodes in the network in succession. A crawler functions by contacting a node directly connected to its host node, adding the contacted node's unique address (i.e., its Internet Protocol, or IP, address or other suitable designation) to a node count list and determining the IP addresses of other nodes directly connected to the contacted node. The crawler than contacts the nodes at each of the newly acquired IP addresses and repeats this process. Once the crawler determiner it has visited every node on the network, it determines the node count by counting the number of unique IP addresses on its node count list.

(2) Implementation of a central server, such as a web server, with whom each node on the network, at periodic intervals, connects to and “checks in” to registers its connection status.

With both of these methods the utilization of network bandwidth and CPU resources increases significantly, and in some cases exponentially, in proportion to the size of the network. In addition, a crawler will take exponentially more time to crawl the network as the network grows. This reduces the accuracy of its results because the longer it takes to crawl the network the more likely it is that nodes will have left or joined the network by the time the results are tallied. The central server model suffers from incurring an ever increasing bandwidth use penalty as the network grows, even in situations in which the central server is offline. There is nothing to prevent this increasing bandwidth cost from overwhelming the central server's internet connection if the network grows large enough.

Another disadvantage of existing peer-to-peer network architectures is that there is no simple or efficient method to controlling the configuration of nodes to meet a changing environment. Known methods for controlling the configuration of nodes in a peer-to-peer network include the following:

(1) Releasing and deploying to each node a new version of the program that controls the node. This requires that every user of the network upgrade their local client software in order for configuration changes to be implemented.

(2) Distributing configuration commands from a central server, which could be any sort of server represented by the traditional client/server model of computing. The server would communicate with the client and pass instructions at that time which would modify the client's configuration parameters.

Again, with both known methods the utilization of network bandwidth and CPU resources increases significantly, and in some cases exponentially, in proportion to the size of the network. Moreover, in the case of the software upgrade method, the implementation of configuration changes will be dependent on the willingness and diligence of users in upgrading the client. With the client/server method, all of the advantages of a decentralized networking method are lost.

Another disadvantage of existing peer-to-peer network architectures is that a node can only be certain that it is connected to a certain number of other nodes (i.e., those it connects to directly.) Such node has no assurance or information as to whether or not it connected via neighboring nodes to the entirety of the rest of the network. It is possible for “islands” of nodes to exist, cut off from the main group of peer-to-peer nodes, if certain key links to the network are severed. It would be advantageous if a node had awareness that it was part of an “island” and could automatically seek reconnection to the network.

Finally, the nodes in known peer-to-peer networks have no way of determining loop free paths between particular nodes. In existing peer-to-peer networks, communications between nodes are transmitted simultaneously along all available pathways. This generally results in a single communication being transmitted multiple times over at least partially redundant paths, a condition commonly referred to as “looped” communication. It would obviously be advantageous if a node could have awareness of the most direct, fastest, non-looping network path to a second node on the network.

Therefore, there is a need in the prior art to provide a method for counting nodes in a peer-to-peer network that consumes less bandwidth and CPU resources than known methods.

There is a further need in the art to provide a method for counting nodes in a peer-to-peer network that does not require a central server to be contacted by each node.

There is a further need in the art to provide a method for counting nodes in a peer-to-peer network whose speed and efficiency is not compromised by network growth.

There is a further need in the art to provide a method for controlling the configuration of nodes in a peer-to-peer network that consumes less bandwidth and CPU resources than known methods.

There is a further need in the art to provide a method for controlling the configuration of nodes in a peer-to-peer network that does not require a central server to be contacted by each node.

There is a further need in the art to provide a method for controlling the configuration of nodes in a peer-to-peer network whose speed and efficiency is not compromised by network growth.

There is a further need in the art to provide a method for controlling the configuration of nodes in a peer-to-peer network that does not require that every user of the network upgrade their local client software in order for configuration changes to be implemented.

There is a further need in the art to provide a peer-to-peer network configured whereby nodes can detect when they become disconnected from the rest of the network and can automatically reestablish a connection.

There is a further need in the art to provide a method for configuring a peer-to-peer network with a loop-free topology that can then be utilized to pass messages among the nodes of the network without incurring the overhead of passing messages repeatedly and redundantly over loops.

Previous attempts at improved peer-to-peer networks and related methods are described in U.S. Pat. No. 5,630,184 to Roper, et al. (the '184 patent); U.S. Pat. No. 5,946,679 to Ahuja et al. (the '679 patent); and U.S. Pat. No. 6,070,187 to Subramaniam et al. (the '187 patent).

The '184 patent describes a network, consisting of computer nodes linked together into a minimum spanning tree topology. When a computer receives a message from a first node linked to it, it forwards the message to other nodes linked to that computer, as well as storing information about the message. As replies are received from the other computers, they are stored and collated together, to allow the computer to send just a single reply message back to the originating node based on the collated replies. This single reply is in turn collated at the next node. The message requests deletion of a particular node from the network. No node deletes the node from the network until replies have been received from all the nodes to which the message was forwarded.

The '679 patent describes a system and method for locating a route in a route table using hashing and compressed radix tree searching. The method and apparatus searches table information using keys of varying lengths. Based on criteria, the method selects one of three processes for performing the search. The first routine is a reverse hash search process which is useful for searching information with few key lengths. The second process is a hierarchical search routine which is useful for searching information with many key lengths. The third process is a compressed radix tree search which is useful for searching information that presents significant time barriers to the first two routines.

The '187 patent describes a method and apparatus for configuring a network node to be its own gateway. A configuration agent allows a network node seeking to be automatically configured with an IP address and a default gateway address to be configured as its own gateway. In first and second embodiments of the present invention, the configuration agent resides on a network device (such as a switch or bridge) that is coupled to two network segments, with one network segments including a node to be configured and another network segment including a server capable of automatically providing configuration parameters. In the first embodiment, the configuration agent acts as a snoopy agent. Messages from the configuration server to the node to be configured are “snooped” to discover messages containing an IP address and a default gateway address. Such messages are altered to copy the IP addresses offered to the nodes seeking configuration to the default gateway addresses, and the messages are sent on their way, thereby causing the node seeking to be configured to be its own default gateway. In the second embodiment of the invention, the configuration acts as a proxy agent. From the point of view of the node to be configured, the proxy agent appears to be a configuration agent. From the point of view of the configuration server, the proxy agent appears to be a relay agent if the configuration server and the node to be configured are on different subnets. When the configuration server sends messages to the node to be configured (possibly treating the proxy agent as a relay agent), the proxy agent intercepts the message and copies the offered IP address to the default gateway address in the message, thereby causing the node seeking to be configured to be configured as its own gateway. The proxy agent also substitutes its IP address for the IP address of the actual configuration server, thereby causing the node seeking to be configured to treat the proxy agent as the configuration agent.

None of the above references describe a method for counting, or controlling the configuration of, nodes in a peer-to-peer network that consumes less bandwidth and CPU resources than known methods, that does not require a central server, and whose speed and efficiency is not compromised by network growth.

Also, none of the above references describe a method for controlling the configuration nodes in a peer-to-peer network that that does not require that every user of the network upgrade their local client software in order for configuration changes to be implemented.

In addition, none of the above references describe a peer-to-peer network whereby nodes can detect when they become disconnected from the rest of the network and can automatically reestablish a connection.

Finally, none of the above references describe a method for automatically configuring a peer-to-peer network with a loop-free topology that can then be utilized to pass messages among the nodes of the network without incurring the overhead of passing messages repeatedly and redundantly over loops.

### SUMMARY OF THE INVENTION

The subject invention resolves the above-described needs and problems by providing a self-defined, automatically-configured hierarchical peer-to-peer networking method. Network hierarchy is determined by the proximity (quantified as lower transmission latency) of nodes in the network to a predetermined special node designated a “heartbeat server” node. Nodes in closer proximity to the heartbeat server node are considered parent of nodes in farther out. Nodes in equal proximity to the server node are considered siblings to each other. The network disclosed has a loop-free connectivity topology where a parent node may have multiple child nodes but does not share any child nodes with other parents.

The disclosed peer-to-peer network configures itself automatically through the use of periodic “heartbeat” messages which originate from the heartbeat server node and are transmitted to nodes immediately connected to it. Each node, in turn, transmits each heartbeat message to other nodes directly connected to them until the message is completely propagated throughout the network. Each heartbeat message generated by the heartbeat server has a unique identifier (i.e., a heartbeat counter) which is consecutively increased as new heartbeat messages are generated. Each heartbeat message is also encrypted to ensure that it cannot be faked or spoofed. Methods of encryption can include public/private key encryption methods or other suitable methods.

The heartbeat message includes several pieces of information. The heartbeat message contains cryptographic authentication information to ensure the authenticity and validity of the information. The heartbeat message contains a 64-bit counter (i.e., the heartbeat counter) which is increased by the heartbeat server with each successive heartbeat. Nodes use the value of this counter to determine if a heartbeat is newer than a previous one they have received. The heartbeat message contains encoded information that each node may interpret as configuration information.

The heartbeat message follows certain rules of propagation. When a node receives a heartbeat message, it first determines whether it is the first time it has received the heartbeat message as identified by the heartbeat counter. If it is, the node immediately re-transmits it to all nodes directly connected to it except the node from which it received the heartbeat message. If it is not (i.e., if the particular heartbeat message has been previously received from another neighboring node) the heartbeat message is not re-transmitted.

The peer-to-peer network hierarchy is determined as follows: (1) a node will consider as its parent the node from which it received a heartbeat message which is newer than the newest heartbeat message it has received; (2) a node will consider as its child any node to which it transmits a heartbeat message and from which it does not also receive the identical heartbeat message; and (3) a node will consider as its sibling any node to which it transmits a heartbeat message and from which it also receives the identical heartbeat message.

After this process is completed, each node in the network will have designated each of its neighboring nodes as its parent, child or sibling. When links between sibling nodes are excluded, a diagrammatic representation of the network topology forms a perfect “spanning tree”, exhibiting loop-free connectivity, and having only one path between any node and any other node. In addition, the path between any node and the heartbeat server node will be inherently optimized for minimum latency. The above process is repeated, and the network “map” updated, with each subsequent heartbeat generated by the heartbeat server node resulting in automatic re-configuration and re-optimization of the network topology.

In addition, the heartbeat server includes remote configuration features. The heartbeat server node can modify the configuration of all nodes on the network for a small fixed cost, simply by sending out a heartbeat message that contains encoded configuration information that the nodes will interpret and use to update their own configuration information. Configuration generally means numerical parameters, such as maximum number of uploads, downloads, host connections, types of accepted host connections, behavior for each host connection, etc. These are the settings which may be found in the setup menu of the node's program, as well as other hidden settings which may not be directly user configurable. Any or all of a node's local numerical configuration settings may be modified by the configuration instructions of the heartbeat message. The nodes will retain this configuration information until they receive a newer heartbeat message which may (or may not) change the previous configuration.

Through the identification information transmitted to the heartbeat server by each node, the heartbeat server has the ability to count the nodes on the network and generate statistics. In addition, the heartbeat server can give special designations to nodes based on their location within the network tree. For example, when a node receives a heartbeat message, and determines that it has no children, then the node is a “leaf node” from the perspective of the heartbeat server. Upon determining that it is a leaf node, a node sends a message called a “stats message” back up to its parent node which contains summary information (i.e., statistics) about the leaf node itself. When the parent node receives stats messages from all its children, it compiles these stats message into a summary stats message which includes all the information about the children as well as itself. The summary stats message includes the total number of nodes connected to the node generating it. This process is repeated at each parent node until the summary stat messages are propagated up the network tree. In this fashion, the heartbeat server will eventually receive the summary stats messages from all nodes on the network without any overlap or redundancy. The heartbeat server can then easily determine the count of the total number of nodes on the network by adding up the values in all the summary stats messages. If a node loses its parent during the stats collection process, then it may forward a marked stats packet to a sibling instead, thereby making the sibling connection into a parent connection.

Statistics which can be collected and included in stat messages are those which are easily aggregative. In order for statistics to be easily aggregative they must satisfy the following conditions: (1) results can be represented compactly and numerically; (2) two or more results can be combined (using minimum, maximum or sum operations) into the storage space of a single result through addition or subtraction, not concatenation; (3) each statistic is capable of having a unique identification and a combination method parameter; and (4) a statistic can accept as its value either a single parameter, or an array of parameters, as long as all the previous criterion still apply.

Using the disclosed methods, each node on the network is capable of determining its connectivity status. A node on the network will monitor the frequency that it hears heartbeat messages. If it has not heard a message with a specified interval, for example three (3) times the measured heartbeat period for previously received heartbeat messages, it will assume that it has lost connection to the part of the network that broadcasts heartbeat messages. Action may be taken based on this information, such as searching for and establishing new connections, or automatically modifying local node configuration parameters. The disclosed invention does not limit the type of action, if any, can be taken by a node when it considers itself disconnected from the network. The connectivity information is made available to other nodes by the heartbeat server mechanism, and an individual embodiment of the invention may decide to utilize the “connectivity information” in various ways.

The resulting peer-to-peer network constitutes a virtual spanning tree topology. The spanning tree generated by the topology “map” is a loop free topology. This loop-free topology is used to pass additional messages along the spanning tree pathways. The advantage of a loop-free topology is that each node receives the message exactly once and not repeatedly across redundant connections. A bandwidth savings is achieved by reducing the redundant communication. The contents of the additional messages is not defined here, but may be any message that the network wishes a node to be able to transmit to the rest of the peer-to-peer network in a bandwidth-optimized fashion.

Accordingly, it is an object of the present invention to provide a method for counting nodes in a peer-to-peer network that consumes less bandwidth and CPU resources than known methods.

It is an additional object of the present invention to provide a method for counting nodes in a peer-to-peer network that does not require a central server to be contacted by each node.

It is an additional object of the present invention to provide a method for counting nodes in a peer-to-peer network whose speed and efficiency is not compromised by network growth.

It is an additional object of the present invention to provide a method for controlling the configuration of nodes in a peer-to-peer network that consumes less bandwidth and CPU resources than known methods.

It is an additional object of the present invention to provide a method for controlling the configuration of nodes in a peer-to-peer network that does not require a central server to be contacted by each node.

It is an additional object of the present invention to provide a method for controlling the configuration of nodes in a peer-to-peer network whose speed and efficiency is not compromised by network growth.

It is an additional object of the present invention to provide a method for controlling the configuration of nodes in a peer-to-peer network that does not require that every user of the network upgrade their local client software in order for configuration changes to be implemented.

It is an additional object of the present invention to provide a peer-to-peer network configured whereby nodes can detect when they become disconnected from the rest of the network and can automatically reestablish a connection.

It is an additional object of the present invention to provide a method for configuring a peer-to-peer network with a loop-free topology that can then be utilized to pass messages among the nodes of the network without incurring the overhead of passing messages repeatedly and redundantly over loops.

These and other objects, features, and advantages of the present invention may be more clearly understood and appreciated from a review of ensuing detailed description of the preferred and alternate embodiments and by reference to the accompanying drawings and claims.

### BRIEF DESCRIPTION OF THE DRAWINGS

FIG. 1 is a diagram of the topology of the heartbeat server.

FIG. 2 is a diagram of the heartbeat broadcast path.

FIG. 3 is a diagram of the stats return path.

FIG. 4 is a representation of the content of the heartbeat message and heartbeat stats.

### DETAILED DESCRIPTION OF THE PREFERRED EMBODIMENT

While the present invention will be described more fully hereinafter with reference to the accompanying drawings, in which a preferred embodiment of the present invention is shown, it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

The following describes a specific implementation, operation and use of a heartbeat server, as embodied in a Gnutella peer-to-peer network.

A heartbeat server is a node on the network which forwards heartbeat messages to its directly connected neighbors. These neighbors forward the message to their neighbors and so on, in the manner of a traditional peer-to-peer query broadcast, with no pre-defined timeout or expiration. All connected nodes in the network will receive the most recent heartbeat message.

The heartbeat server will send out these messages at regular cycles for as long as it is in operation. A cycle can be defined, for example, as a period greater than 20 seconds and no less that the lesser of 5 minutes and the time for all nodes on the peer-to-peer to respond to a heartbeat/stats request.

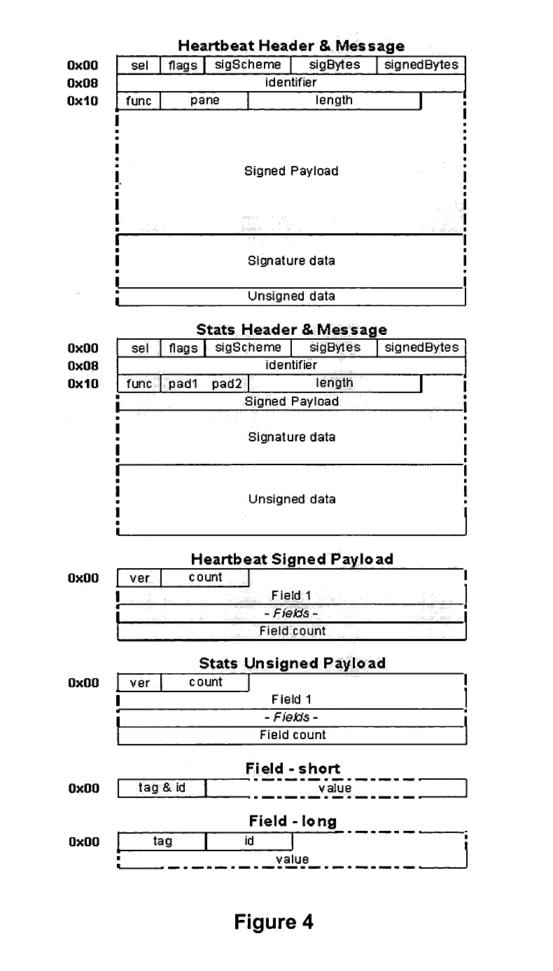

Referring now to FIG. 4, shown are the contents of a typical heartbeat message and its format. The heartbeat message is comprised of four sections: the header, the signed payload, the signature data, and the unsigned data. The header contains information specific to the current heartbeat being issued. Such information includes: sel—selector to indicate message type (Heartbeat); flags—reserved; sigScheme—identifies the specific verification and signature scheme used to sign data; sigBytes—size of the signature data; signedBytes—number of bytes upon which the signature is computed (includes header, which is signed); identifier—a unique identifier for each heartbeat, two heartbeats with the same identifier are treated as the same heartbeat; func-0xf0-0xff—identifies this packet as a non-standard Gnutella message; pane—number which describes the “version” of heartbeat message (this allows incompatible changes to be made to the format of a heartbeat message without breaking support for older clients.) and; length—total length of the heartbeat message.

The signed payload contains a list of requested statistics, as well as values to display to user for the previous cycle. The signed payload may include: ver—0x01, version of CompactFields storage code to use; count—number of individual Fields stored in this message; and Fields—0 or more Fields requesting stats containing 0 or more bytes of data to display to the user.

The signature data contains the digital signature of the signed portion of the heartbeat message. The unsigned data contains data that will change from node to node and includes: hops—number of hops that the heartbeat has traveled so far.

Referring again to FIG. 4, shown are the contents of a stats message and its format. The stats message is also comprised of the same four parts found in the heartbeat message. Those four sections are the header, the signed payload, the signature data, and the unsigned data. The header contains information specific to the current heartbeat the particular stats packet was generated in response to. Such information may comprise: sel—selector to indicate message type (Stats); flags—used to control the flow of heartbeat and stats from node to node and to signal nodes to take an action; sigScheme—identifies the specific verification and signature scheme used to sign data; sigBytes—size of the signature data; signedBytes—number of bytes upon which the signature is computed (includes header, which is signed); identifier—a unique identifier for each heartbeat, two heartbeats with the same identifier are treated as the same heartbeat; func-0xf0-0xff—identifies this packet as a non-standard Gnutella message; pad—unused; and length—total length of the heartbeat message.

The signed payload contains sensitive stats Fields for which complete authenticity is required. The signature data contains the digital signature of the signed portion of the stats message. The unsigned data contains Stats Fields for non-critical statistics, whose authenticity is not needed. Included are: ver—0x01 version of CompactFields storage code to use; count—number of individual Fields stored in this message; and Fields—0 or more Fields of requested stats.

Fields are comprised of three main parts: the control tag, ID, and data. The control tag contains a set of flags indicating the accumulation method appropriate for the given stat. The ID contains a unique identifier for the stat, comprised of a category ID and a specific ID. Depending upon the values stored in the Control Tag, this ID may be encoded in the same bytes as the Control Tag. The data contains the specific aggregated data to collect, send, or display to the user, depending upon context. This data can include a list of parameters modifying the statistic collection formula as well, if it is sent in a heartbeat message, and if it is of the appropriate aggregation type.

The heartbeat message follows certain rules of propagation. If a node receives a message that is older than one previously heard from a “source node”, the newer message is sent in response. If a node receives a message that is the same as one previously heard, it responds with a duplicate of that message. In the later case, the “source node” is now identified as a “sibling node” in the created network topology. This can only happen for both the receiving and sending nodes together; they cannot have different assessments of the “sibling-ness” of a given connection, because both nodes would have followed the same propagation rules (as listed below) in response to the first instance of the message being received. In addition, each node can remember (on a per-sibling basis) the hops that a duplicate heartbeat has traveled, and therefore the “tier” of that sibling in the spanning tree.

If a node receives a newer message from a “source node”, it forwards the message to all its neighbors. In addition, this “source node” is marked as a “parent node” in the created network topology. All neighbors to which the node forwards the message which are not also considered “siblings” will be marked as a “child node” in the created network topology.

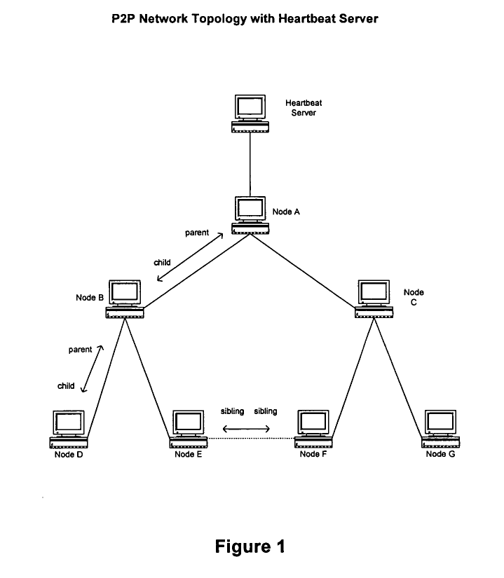

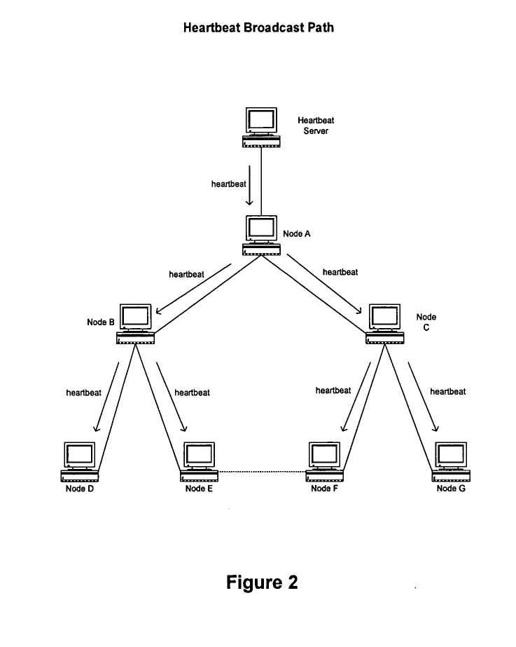

Referring now to FIGS. 1 and 2 which illustrate the peer-to-peer hierarchy and discovery process. If a node receives a newer heartbeat from one of its directly connected neighbors, that neighbor is considered a “parent”. A node can have only one “parent”, and is guaranteed to be a “child” of that node. If a node sends a new heartbeat to one of its directly connected neighbors, without hearing a new heartbeat from that neighbor, the neighbor is considered a “child”. If a node sends a new heartbeat to one of its directly connected neighbors, and then receives that same heartbeat from the same neighbor, the neighbor is considered a “sibling”. By definition, both sides of the sibling connection will identify each other as siblings.

The heartbeat server has pathwise connectivity. A graph may be created from this topology information which only takes into account parent-child relationships, and which ignores the sibling relationships. This will form a perfect spanning tree topology with loop-free connectivity between all nodes in the graph. There is only one path between any node and the root of the tree (the heartbeat server). There is only one internal path between any node and any other node, and this internal path consists of only other heartbeat capable nodes.

The heartbeat server is capable of remote configuration. The heartbeat server modifies the configuration of all nodes on the network for a small fixed cost, simply by sending out a special heartbeat message, “Remote Config”, which contains encoded configuration information that the nodes will interpret and use to update their own configuration information. This special message does not generate any stats, nor does it create virtual network topology. Message propagation occurs exactly like a “standard” heartbeat message, with one key exception: A “Remote Config” message is saved across launches of the application. At all connection establishments, an identifier for the latest stored “Remote Config” is exchanged. A node containing a newer “Remote Config” will then broadcast the newer configuration to the node with the older one, which initiates the heartbeat broadcast propagation rules defined earlier.

The use of the term “configuration” means generally, numerical parameters and settings such as maximum number of uploads, downloads, host connections, types of accepted host connections, behavior for each host connection and so on. These are the settings which may be found in the setup menu of the node's program, as well as other hidden settings which may not be directly user configurable. Any or all of a node's local configuration settings may be modified by the configuration instructions of the heartbeat message.

The nodes will retain this configuration information until they receive a newer heartbeat message, which may or may not change the previous instructions. In all cases, receipt of a newer, valid Remote Config message will cause an older, saved Remote Config message to be discarded, and the newer one to be propagated and saved. Examples of remotely configurable settings include: (1) Host connections desired, (2) Heartbeat connections desired, (3) Maximum simultaneous downloads, and (4) Maximum simultaneous uploads.

The heartbeat server counts the nodes on the network and generates statistics. When a node hears a new heartbeat for the first time, it sets a 5 (five) second counter, and a flag indicating that its statistics have changed (i.e., the “stats changed” flag), and will need to be reported to its parent. When a node receives a heartbeat, and determines that it has no “heartbeat child nodes”, the node is a “spanning leaf node” from the perspective of the heartbeat server. Upon determining that it is a spanning leaf node, a node will locate the requested Stat IDs in the corresponding heartbeat message, and will include its computed contribution to each stat it understands, as well as incrementing the count of “non-understood nodes for stat ID N” for each Stat ID ‘N’ it doesn't understand, if requested in the heartbeat. Once completed, a node sends an immediate “stats message” back up to its parent node, which contains the computed summary information about the spanning leaf node itself. It also disables the 5-second stats timer, and re-sets its “stats changed” flag to false.

When a spanning parent node hears a stats packet from its child, it sets its “stats changed” flag to true indicating that the combined statistics (for the node and its spanning children) have changed. When the 5-second stats timer signals, if the “stats changed” flag is set, it is cleared, the combined stats contribution of the node and its spanning children is computed, and the combined statistics contribution is transmitted, in a stats message, to the node's parent. The expired 5 second counter is then re-set to 5 seconds. This is done to ensure that every time a new contribution is received by the node, which changes the combined stats, the node's parent is notified not more often than once every 5 seconds, if changes occur more rapidly.

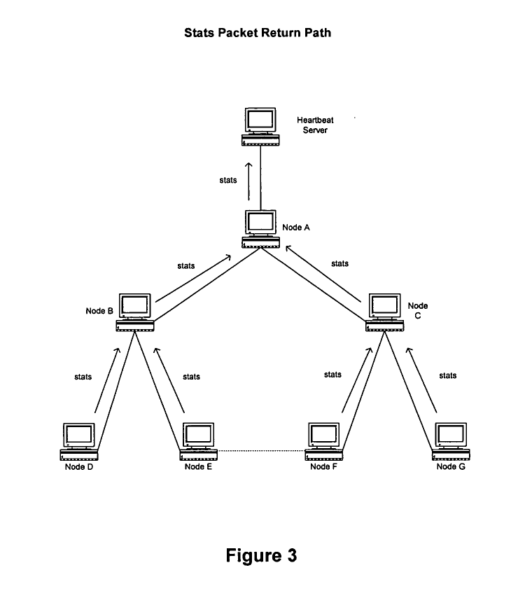

Referring now to FIG. 3, when the parent node receives stats messages from all its children, it compiles these stats message into a summary stats message, which includes all the information about the children as well as itself. This will include the total number of nodes seen so far as children under this current node. Parents send their summary stats messages up the network tree. The heartbeat server will eventually receive the summary stats messages from all the nodes on the network. This includes the count of the total number of nodes on the entire peer-to-peer network, as determined by adding up the values in all the summary stats messages. It also includes the count of children nodes that have not responded so far (uncounted), as well as the largest number of network segments that the heartbeat message traveled.

Statistics that can be collected are those stats that are “easily aggregative”. These statistics must satisfy the following conditions: (1) results can be represented compactly and numerically. (2) two or more results can be combined (using minimum, maximum or sum operations and combinations of those operators) into a single result that consumes the storage space of a single operand. In other words, it utilizes combination, not concatenation. (3) Each statistic is capable of receiving an id and a combination method. These parameters are unique for each statistic. (4) A statistic can accept as its value either a single value, or an array of values (if requested by the heartbeat server), as long as all previous criterion still apply. (5) Statistics have an aggregation method that uniquely identifies the combination scheme, data width (8 bits, 16 bits, 32 bits, 64 bits, etc), and location of stored data and parameters internal to a given stats message. This is done so that the combination of a statistic is independent of the real-world interpretation of that statistic, and allows a parent who does not understand a particular statistic to still correctly combine child stats for that statistic. This allows a large degree of forward and backward compatibility and for the “pluging in” of new statistics as desired later on. This entire layout scheme is called the “Blind Combination Engine”

Examples of statistics that can be collected include: Heartbeat capable Ultrapeer count; Heartbeat capable Leaf count; Hops Max; Hostile node count; Uncounted branches; Uncounted leaves; Library files (shared & unshared); Library Bytes (shared & unshared); File Transfers (downloads & uploads) (obsolete); Non heartbeat leaves; Non heartbeat peers; Downloads (active, waiting); Uploads (active, queued); Cached alternate locations (sum div 4); Ultrapeer dropped hostile queries; Ultrapeer received peer-to-peer network hash queries per second; Ultrapeer received peer-to-peer network name queries per second; Ultrapeer received Non-peer-to-peer network hash queries per second; Ultrapeer received Non-peer-to-peer network name queries per second; Automated FindMoreSources (attempted & hits); Manual FindMoreSources (attempted & hits.)

The heartbeat server is capable of determining connectivity. A given “branch” of the spanning tree can become “detached” below a given node if that node goes offline, and there are no sibling links that cross the branch boundary (there are no siblings of that branch, or the sibling connections are all internal to that branch). When this happens, the topmost child node will realize that it has lost its connection to its parent. In this case, reconnecting the topmost branch parent can reconnect the entire branch. As such, only that one node need establish or break connections in an attempt to learn of a newer heartbeat, and only in the rare case where all of the branches' sibling links are internal to that branch. In any case, if there exists an external sibling connection that links the disconnected branch to the rest of the spanning tree, then the next heartbeat cycle will redraw the local topology with the “topmost branch parent” as a child of the “externally-sibling-connected” node, and the entire branch will be counted in the next cycle.

Accordingly, it will be understood that the preferred embodiment of the present invention has been disclosed by way of example and that other modifications and alterations may occur to those skilled in the art without departing from the scope and spirit of the appended claims.

1. A method for mapping a hierarchical peer-to-peer network having a loop-free spanning tree topology, said network comprising a plurality of nodes, wherein said nodes may connect to or disconnect from the network dynamically, the method comprising the steps of:
a. generating heartbeat network message at a first node, said heartbeat network message containing information which uniquely identifies it;
b. transmitting said heartbeat network message to all nodes directly connected to said first node;
c. at each node receiving said heartbeat network message, re-transmitting said heartbeat network message to each node directly connected to said receiving node with the exception of the node from which said heartbeat network message was originally received;
d. repeating step “c” at every node on the network until said heartbeat network message is fully propagated throughout the network;
e. designating each said receiving node as a parent, child or sibling with respect to each node to which it is directly connected wherein a parent node may have one or more child nodes directly connected to it and wherein a child node has exactly one parent node and may have multiple sibling nodes directly connected to it; and
f. periodically repeating steps “a” through “e”;

2. The method of claim 1 wherein:
a. said network heartbeat message additionally contains information which identifies the time when it was generated relative to other network heartbeat messages
b. a receiving node will designate as its parent, the node to which it is directly connected and from which it first receives a heartbeat network message which is newer than the newest heartbeat network message previously received;
b. a receiving node will designate as its sibling, each node to which it is directly connected, to which it transmits a heartbeat network message, and from which it receives an identical heartbeat network message; and
c. a receiving node will designate as its child, each node to which it is directly connected, to which it transmits a heartbeat network message, and from which it does not receive an identical heartbeat network message.

3. The method of claim 1 wherein said heartbeat network message contains additional configuration information which determines the operational configuration of the node receiving it.

4. A method for counting the number of nodes in a hierarchical peer-to-peer network having a loop-free spanning tree topology, said network comprising a plurality of nodes, wherein said nodes may connect to or disconnect from the network dynamically, the method comprising the steps of:
a. generating a uniquely identified heartbeat network message at a first node;
b. transmitting said heartbeat network message to all nodes directly connected to said first node;
c. at each node receiving said heartbeat network message, re-transmitting said heartbeat network message to each node directly connected to said receiving node;
d. repeating step “c” at every node on the network until said heartbeat network message is fully propagated throughout the network;
e. designating each said receiving node as a parent, child or sibling with respect to each node to which it is directly connected wherein a parent node may have one or more child nodes directly connected to it and wherein a child node has exactly one parent node and may have multiple sibling nodes directly connected to it;
f. periodically repeating steps “a” through “e”;
g. designating each said receiving node which does not have any child nodes as a leaf node;
h. at each such leaf node, generating a stats message and transmitting said stats message to its parent node, said stats message having a node count variable set to the value of 1;
i. at each parent node receiving said stats messages from its child nodes, generating a new node count value by arithmetically adding the node count values from all said stats messages and increasing the resulting count by 1, generating a new stats message having said new node count value, and transmitting said new stats message to its parent node;
j. repeating step “i” at every node on the network until said first node has received stats messages from all nodes directly connected to it; and
k. at said first node, generating a total node count for the network by arithmetically adding the node count values from all received stats messages.

5. The method of claim 4 wherein:
a. said network heartbeat message additionally contains information which identifies the time when it was generated relative to other network heartbeat messages
b. a receiving node will designate as its parent, the node to which it is directly connected and from which it first receives a heartbeat network message which is newer than the newest heartbeat network message previously received;
b. a receiving node will designate as its sibling, each node to which it is directly connected, to which it transmits a heartbeat network message, and from which it receives an identical heartbeat network message; and
c. a receiving node will designate as its child, each node to which it is directly connected, to which it transmits a heartbeat network message, and from which it does not receive an identical heartbeat network message.

6. A method for collecting statistics in a hierarchical peer-to-peer network having a loop-free spanning tree topology, said network comprising a plurality of nodes, wherein said nodes may connect to or disconnect from the network dynamically, the method comprising the steps of:
a. generating a uniquely identified heartbeat network message at a first node;
b. transmitting said heartbeat network message to all nodes directly connected to said first node;
c. at each node receiving said heartbeat network message, re-transmitting said heartbeat network message to each node directly connected to said receiving node;
d. repeating step “c” at every node on the network until said heartbeat network message is fully propagated throughout the network;
e. designating each said receiving node as a parent, child or sibling with respect to each node to which it is directly connected wherein a parent node may have one or more child nodes directly connected to it and wherein a child node has exactly one parent node and may have multiple sibling nodes directly connected to it;
f. periodically repeating steps “a” through “e”;
g. designating each said receiving node which does not have any child nodes as a leaf node;
h. at each such leaf node, generating a stats message and transmitting said stats message to its parent node, said stats message having one or more network statistics values corresponding to said leaf node;
i. at each parent node receiving said stats messages from its child nodes, generating new set of network statistics values by combining the network statistics values from all said received stats messages, and transmitting said new stats message to its parent node;
j. repeating step “i” at every node on the network until said first node has received stats messages from all nodes directly connected to it; and
k. at said first node, generating a total network statistics values by combining the network statistics values from all received stats messages.
